(19) United States
(12) Patent Application Publication
(10) Pub. No.: US 2023/0087632 A1
(43) Pub. Date: Mar. 23, 2023

(54) OPEN GANGWAY FOR RAIL VEHICLE AND RAIL VEHICLE HAVING SAME

(71) Applicant: BYD COMPANY LIMITED, SHENZHEN, GUANGDONG (CN)

(72) Inventors: Junfu LUO, Shenzhen (CN); Shangjing NING, Shenzhen (CN)

(21) Appl. No.: 17/798,839

(22) PCT Filed: Jan. 6, 2021
(86) PCT No.: PCT/CN2021/070512

§ 371 Date: Aug. 10, 2022

(30) Foreign Application Priority Data
Feb. 28, 2020 (CN) 202010129584.8

(51) Int. Cl. B61D 17/22; B60D 5/00

(52) U.S. Cl. CPC B61D 17/22; B60D 5/00

(57) ABSTRACT

A gangway for a rail vehicle and a rail vehicle having the same are disclosed. The gangway includes: a bellow assembly, a step plate assembly, and a load-bearing assembly. The bellow assembly includes an outer bellow and an inner bellow. The inner bellow is non-symmetrically arranged with respect to a vertical centerline of the outer bellow. The step plate assembly is arranged at a bottom of the inner bellow, to form a passageway in combination with the inner bellow. The load-bearing assembly is arranged within the outer bellow and below the step plate assembly. The load-bearing assembly includes a coupler and a support assembly. The support assembly is connected with the outer bellow and the coupler. A part of the step plate assembly is arranged directly above the coupler. In the gangway of the present disclosure, the load-bearing assembly is arranged within the outer bellow, a coupler avoidance recess is not required to be formed on the outer bellow, and a part of the step plate assembly may be arranged directly above the coupler, thereby providing a more spacious passageway.

### CROSS-REFERENCE TO RELATED APPLICATIONS

The present disclosure claims priority to Chinese Patent Application No. 202010129584.8 filed by the BYD Co., Ltd. on Feb. 28, 2020 and entitled “OPEN GANGWAY FOR RAIL VEHICLE AND RAIL VEHICLE HAVING SAME”, which is incorporated herein by reference in its entirety.

### FIELD

The present disclosure relates to the technical field of rail vehicles, and more specifically, to a gangway for a rail vehicle and a rail vehicle having the same.

### BACKGROUND

In the technical field of rail vehicles, a gangway is configured to connect two adjacent carriages of a rail vehicle. In some gangways in related art, an inner bellow is asymmetrically arranged within an outer bellow. However, a passageway of such gangway is relatively narrow and has poor passability.

### SUMMARY

The present disclosure resolves at least one of the technical problems existing in the related art. The present disclosure provides a gangway for a rail vehicle, so that a passageway of the gangway is relatively spacious, thereby improving passability in the carriages.

The present disclosure further provides a rail vehicle having the above gangway.

The gangway for a rail vehicle according to an embodiment of a first aspect of the present disclosure includes: a bellow assembly, including an outer bellow and an inner bellow fixed within the outer bellow, where a vertical centerline of the inner bellow is offset from a vertical centerline of the outer bellow, so that the inner bellow is non-symmetrically arranged with respect to the vertical centerline of the outer bellow; a step plate assembly, arranged within the outer bellow and at a bottom of the inner bellow, to form a passageway in combination with the inner bellow; and a load-bearing assembly, arranged within the outer bellow and below the step plate assembly, and including a coupler and a support assembly, where the support assembly is connected with the outer bellow and the coupler, and a part of the step plate assembly is arranged directly above the coupler.

According to the gangway for a rail vehicle according to the embodiment of the first aspect of the present disclosure, for the gangway in which the inner bellow is non-symmetrically arranged with respect to the vertical centerline of the outer bellow, the load-bearing assembly is arranged within the outer bellow, so that a coupler avoidance recess is not required to be formed on the outer bellow, and a part of the step plate assembly may be arranged directly above the coupler, thereby providing a more spacious passageway. In addition, it may be ensured that a center of gravity of the entirety of the gangway is relatively low, thereby enhancing smoothness and safety of the rail vehicle during traveling.

In some embodiments, a transverse dimension W2 of the step plate assembly is greater than half of a maximum transverse width W1 of the outer bellow.

In some embodiments, the outer bellow includes a middle connecting frame, a bottom frame of the middle connecting frame is a straight rim, and the support assembly is connected to the bottom frame.

In some embodiments, the support assembly includes: a support arm, extending in a transverse direction, where both ends of the support arm are connected with the outer bellow; and a support plate, connected with the coupler, where a part of the support plate is supported on a bottom of the support arm, the support plate and the support arm are movable relative to each other in the transverse direction, and the support plate and the support arm are frictionally engaged through a first wear-resistant structure.

In some embodiments, the support plate includes: a base plate, connected with the coupler, where a part of the base plate is supported on the bottom of the support arm; and two limit members, arranged on the base plate, where the two limit members are arranged respectively on two longitudinal sides of the support arm, to limit relative positions of the support arm and the base plate.

In some embodiments, the first wear-resistant structure includes: a first wear-resistant member, arranged on the bottom and the two longitudinal sides of the support arm; and a second wear-resistant member, arranged on a top surface of the base plate.

In some embodiments, the step plate assembly includes: two step plates, where the two step plates are longitudinally spaced and are respectively connected with two adjacent carriages; a bridge plate, arranged above and between the two step plates and movably connected with the two adjacent carriages through connecting members below the step plates; and floating plates, respectively arranged on two longitudinal sides of the bridge plate, where each of the floating plates is movably connected with the bridge plate and is lapped above the step plate on a corresponding side.

In some embodiments, the floating plate includes a plurality of sub-floating plates arranged in sequence in an extending direction of a corresponding side edge of the bridge plate. One end of each of the sub-floating plates is pivotally connected with the bridge plate through a hinge, and another end of the sub-floating plate is lapped above the step plate on the corresponding side.

In some embodiments, the floating plate and the step plates are frictionally engaged through a second wear-resistant structure, and the second wear-resistant structure is arranged on the other end of the sub-floating plate.

In some embodiments, the bridge plate and the step plates are frictionally engaged through a third wear-resistant structure. The third wear-resistant structure includes: a wear-resistant strip, arranged on a bottom of the bridge plate on each of the two longitudinal sides of the bridge plate; and a wear-resistant plate, arranged on a top surface of each of the step plates.

A rail vehicle according to an embodiment of a second aspect of the present disclosure includes multiple carriages and the gangway for a rail vehicle according to the embodiment of the first aspect of the present disclosure. The gangway is connected between two adjacent carriages.

According to the rail vehicle of the embodiment of the second aspect of the present disclosure, the gangway for a rail vehicle of the first aspect is arranged, and the inner bellow of the gangway is non-symmetrically arranged with respect to the vertical centerline of the outer bellow, thereby providing a more spacious passageway, and improving the passability in the carriages. In addition, the load-bearing assembly is arranged within the outer bellow and below the step plate assembly, which can lower the center of gravity of the gangway, thereby enhancing the smoothness and safety of the rail vehicle during traveling.

Additional aspects and advantages of the present disclosure will be given in the following description, some of which will become apparent from the following description or may be learned from practices of the present disclosure.

### BRIEF DESCRIPTION OF THE DRAWINGS

FIG. 1 is a front view of a gangway according to an embodiment of the present disclosure;

FIG. 2 is a schematic diagram of a partial bellow frame of an outer bellow shown in FIG. 1;

FIG. 3 is an enlarged view of the part A shown in FIG. 1;

FIG. 4 is a three-dimensional view of the support assembly shown in FIG. 1;

FIG. 5 is a three-dimensional view of the step plate assembly shown in FIG. 1;

FIG. 6 is a three-dimensional view of the step plate assembly shown in FIG. 5 from another angle;

FIG. 7 is an enlarged view of a part B shown in FIG. 6;

FIG. 8 is a three-dimensional view of the step plate support shown in FIG. 5;

FIG. 9 is a three-dimensional view of connecting members shown in FIG. 6;

FIG. 10 is a cross-sectional view of the bridge plate shown in FIG. 5;

FIG. 11 is a three-dimensional view of the gangway shown in FIG. 1;

FIG. 12 is a schematic diagram of a rail vehicle according to an embodiment of the present disclosure; and

FIG. 13 is a front view of a gangway according to an embodiment in related art.

### REFERENCE NUMERALS

Rail vehicle 1000;

Gangway 100; Carriage 200;

Bellow assembly 1; Passageway 1a;

Outer bellow 11; Sub-bellow 110;

Middle connecting frame 111; Bottom frame 112 of middle connecting frame; Vehicle body connecting frame 113;

Inner bellow 12; Skirt assembly 13; First connecting rod 14; Second connecting rod 15;

Vehicle body mounting frame 16; Lug structure 17; Rubber strip 18; Double-layer bellow fabric 19;

Step plate assembly 2;

Step plate 21; Mounting hole 211; Bridge plate 22; Floating plate 23; Sub-floating plate 23a;

Connecting member 24; Rotatable member 241;

Step plate support 25; Mounting portion 251; Connecting portion 252; Through hole 2521; Support portion 253;

Hinge 26;

Load-bearing assembly 3; Coupler 31;

Support assembly 32; Support arm 321; Support plate 322; Base plate 3221; Limit member 3222;

First wear-resistant structure 4; First wear-resistant member 41; Second wear-resistant member 42; Avoidance hole 421;

Second wear-resistant structure 5; Third wear-resistant structure 6; Wear-resistant strip 61; Wear-resistant plate 62;

Gangway in related art 100A;

Outer bellow in related art 11A; Inner bellow in related art 12A;

Upper avoidance recess in related art 11A1; Protruding portion in related art 11A2;

Passageway in related art 1A, and step plate assembly in related art 2A; and

Coupler in related art 31A.

### DETAILED DESCRIPTION

Embodiments of the present disclosure are described in detail below, and examples of the embodiments are shown in the accompanying drawings, where the same or similar elements or the elements having same or similar functions are denoted by the same or similar reference numerals throughout the description. The embodiments described below with reference to the accompanying drawings are exemplary, and for explaining the present disclosure and cannot be construed as a limitation to the present disclosure.

The present disclosure below provides many different embodiments or examples for implementing different structures of the present disclosure. To simplify the disclosure of the present disclosure, the following describes components and settings of particular examples. Certainly, the components and settings are merely examples, and do not limit the present disclosure. In addition, the present disclosure may repeat reference numerals and/or letters in different instances. This repetition is for simplicity and clarity, which itself does not indicate a relationship between the embodiments and/or arrangements discussed. In addition, the present disclosure provides examples of various specific processes and materials, but a person skilled in the art may be aware of the applicability of other processes and/or the use of other materials.

With reference to the accompanying drawing, a gangway 100 for a rail vehicle 1000 according to an embodiment of a first aspect of the present disclosure is described below.

As shown in FIG. 1, the gangway 100 for a rail vehicle 1000 according to the embodiment of the first aspect of the present disclosure may include a bellow assembly 1, a step plate assembly 2, and a load-bearing assembly 3. The bellow assembly 1 includes an outer bellow 11 and an inner bellow 12. The inner bellow 12 is fixed within the outer bellow 11. A vertical centerline L2 of the inner bellow 12 is offset from a vertical centerline L1 of the outer bellow 11, so that the inner bellow 12 is non-symmetrically arranged with respect to the vertical centerline L1 of the outer bellow 11. The step plate assembly 2 is arranged within the outer bellow 11 and at a bottom of the inner bellow 12, so as to form a passageway 1a in combination with the inner bellow 12. The load-bearing assembly 3 is arranged within the outer bellow 11 and below the step plate assembly 2. The load-bearing assembly 3 includes a coupler 31 and a support assembly 32. The support assembly 32 is connected with the outer bellow 11 and the coupler 31. That is to say, the outer bellow 11 is connected to the coupler 31 through the support assembly 32, so that a weight of the bellow assembly 1 is borne by the coupler 31. In this way, the weight of the bellow assembly 1 is pressed on the coupler 31 inside the bellow assembly, and a part of the step plate assembly 2 is arranged above the coupler 31.

It should be noted that, in the expression that “the support assembly 32 is connected with the outer bellow 11 and the coupler 31”, a manner in which the support assembly 32 is connected with the outer bellow 11 and a manner in which the support assembly 32 is connected with the coupler 31 are not limited. For example, the connection manner may be a fixed connection, a detachable connection, a direct connection, an indirect connection, or the like, which is not limited herein. In addition, it may be understood that the coupler 31 is configured to hook and connect two adjacent carriages 200 connected through the gangway 100.

In addition, it should be noted that the vertical centerline L2 of the inner bellow 12 is offset from the vertical centerline L1 of the outer bellow 11, which means that the vertical centerline L1 of the outer bellow 11 and the vertical centerline L2 of the inner bellow 12 do not overlap and are spaced apart by a certain distance. For example, in a specific embodiment shown in FIG. 1, the vertical centerline L1 of the outer bellow 11 is located on a right side of the vertical centerline L2 of the inner bellow 12. In this case, a distance between a left side edge of the inner bellow 12 and a left side edge of the outer bellow 11 is H1, and a distance between a right side edge of the inner bellow 12 and a right side edge of the outer bellow 11 is H2. H1<H2, so that the inner bellow 12 is non-symmetrically arranged with respect to the vertical centerline L1 of the outer bellow 11.

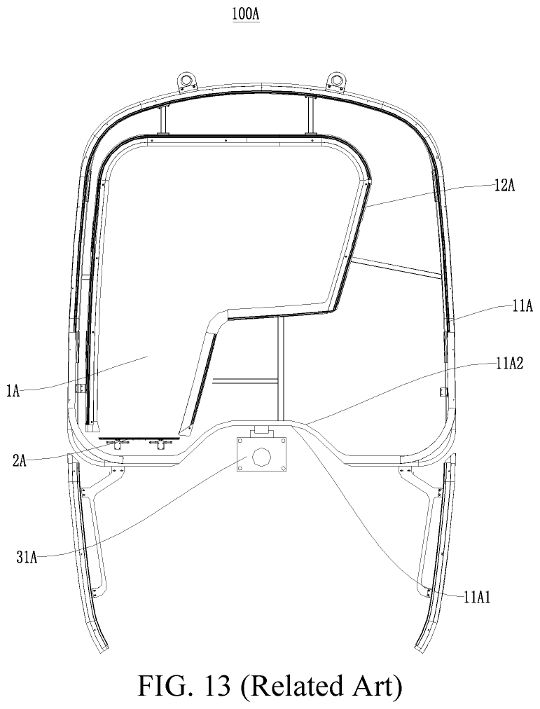

With reference to FIG. 13, in a gangway 100A in related art, in order to facilitate mounting of the gangway 100A, an outer bellow 11A is generally directly arranged on a coupler 31A. In this case, the outer bellow 11A is located above the coupler 31A, and the coupler 31A is located below a bottom outside the outer bellow 11A. For the gangway 100A in which an inner bellow 12A is non-symmetrically arranged with respect to the vertical centerline of the outer bellow 11A, in order to ensure smooth running of the vehicle, the coupler 31A is generally arranged relatively high. In this case, if the bottom of the outer bellow 11A is a plane, a height of a step plate assembly 2A on a bottom surface of a passageway 1A is to be relatively large, resulting in a higher center of gravity of the vehicle and unstable running.

Therefore, in order to lower the center of gravity of the vehicle, the arranging height of the step plate assembly 2A on the bottom surface of the passageway 1A is required to be reduced. Therefore, a bottom height of the outer bellow 11A is required to be reduced accordingly. In order to avoid interference between the outer bellow 11A and the coupler 31A when the outer bellow 11A is lowered, an upper avoidance recess 11A1 configured to avoid the coupler 31A is required to be arranged on the bottom of the outer bellow 11A, so that the coupler 31A is accommodated in the upper avoidance recess 11A1. In this way, the bottom height of the outer bellow 11A can be reduced, and the height of the step plate assembly 2A can be reduced.

However, when the upper avoidance recess 11A1 is formed on the bottom of the outer bellow 11A, a protruding portion 11A2 that protrudes upward is formed on an inner bottom of the outer bellow 11A. In order to ensure that the height of the step plate assembly 2A is relatively low and the protruding portion 11A2 can be avoided, the step plate assembly 2A is required to be arranged on a transverse side of the protruding portion 11A2. In this case, although the height of the step plate assembly 2A can be reduced, a width of a lower portion of the passageway 1A may also be reduced.

In the embodiment of the present disclosure, as shown in FIG. 1, the load-bearing assembly 3 is arranged within the outer bellow 11, so that the upper avoidance recess 11A1 configured to avoid the coupler 31 is not required to be formed on the bottom of the bellow assembly 1, and a transverse extending width of the step plate assembly 2 does not need to be limited in order to avoid the upper avoidance recess 11A1. Therefore, a part of the step plate assembly 2 may extend to a position directly above the coupler 31 while maintaining an original height or even lowering a certain height, thereby providing a more spacious passageway 1a. In addition, the height of the step plate assembly 2 is relatively small, thereby ensuring a relatively low center of gravity of the gangway 100, and enhancing the running smoothness and safety of the rail vehicle 1000.

According to the gangway 100 for a rail vehicle 1000 of the embodiment of the first aspect of the present disclosure, for the gangway 100 in which the inner bellow 12 is non-symmetrically arranged with respect to the vertical centerline of the outer bellow 11, although the coupler 31A is arranged relatively high, the load-bearing assembly 3 is arranged within the outer bellow 11, so that the upper avoidance recess 11A1 configured to avoid the coupler 31 is not required to be formed on the outer bellow 11. In this way, a part of the step plate assembly 2 may extend to a position directly above the coupler 31, thereby providing a more spacious passageway 1a. In addition, it may be ensured that a center of gravity of the entirety of the gangway 100 is relatively low, thereby enhancing smoothness and safety of the rail vehicle 1000 during traveling.

In some embodiments, as shown in FIG. 1, a transverse dimension W2 of the step plate assembly 2 is greater than half of a maximum transverse width W1 of the outer bellow 11 (that is, W2>W1/2). Therefore, when the step plate assembly 2 forms the passageway 1a in combination with the inner bellow 12, a width of the passageway 1a is relatively large, thereby improving the passability in the carriages 200.

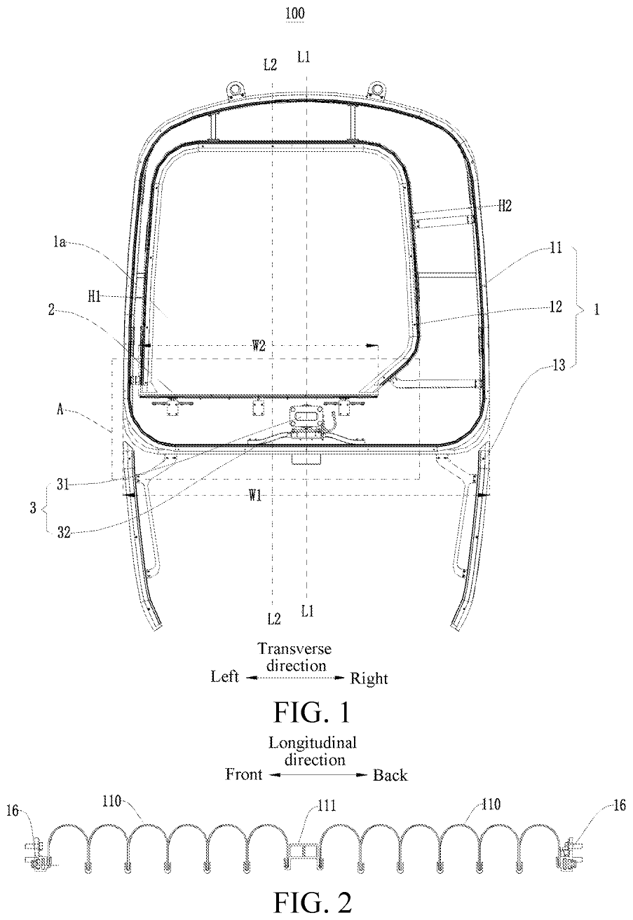

In some embodiments, as shown in FIG. 2, the outer bellow 11 may include a middle connecting frame 111. The outer bellow 11 includes two sub-bellows 110 correspondingly connected with two adjacent carriages 200. When the middle connecting frame 11 has a quick uncoupling structure, the middle connecting frame 111 may be divided into two separable sub-frames. The two sub-frames are connected through the quick uncoupling structure, and the two sub-frames are correspondingly connected with the two sub-bellows 110. During mounting, the two sub-bellows 110 are correspondingly mounted behind the two carriages 200, then the coupler 31 is mounted in place, and then the two sub-frames are connected through the quick uncoupling structure. In this way, the mounting can be simple and convenient. It may be understood that a specific form of the quick uncoupling structure is not limited, and details will not be described herein.

Certainly, the present disclosure is not limited thereto. In some other embodiments, the middle connecting frame 111 may not be provided with a quick uncoupling structure. In this case, the sub-bellows 110 are respectively fixed to two sides of the middle connecting frame 111. During the mounting, one of the sub-bellows 110 may be connected with the carriage 200 on a corresponding side, then the coupler 31 may be mounted in place, and then the other sub-bellow 110 may be connected with the carriage 200 on the other side. In this way, the mounting can be simple and convenient.

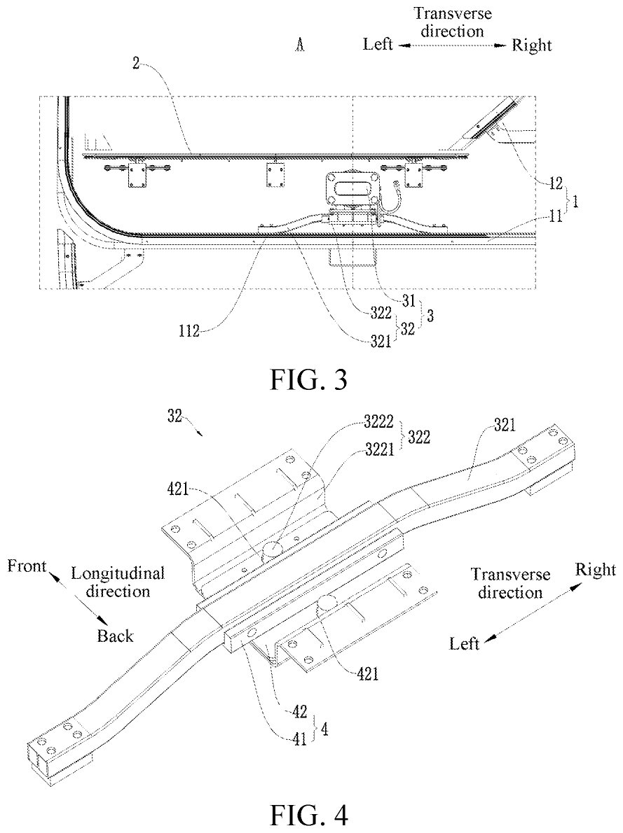

With reference to FIG. 3, a bottom frame 112 of the middle connecting frame 111 is a straight rim, that is to say, the middle connecting frame has no structure that protrudes upward or downward, and extends along a straight line. The support assembly 32 is connected to the bottom frame 112. For example, the support assembly 32 may be connected to the bottom frame 112. Since the bottom frame 112 is a straight rim, the middle connecting frame 111 has a simple structure, is convenient to process, has desirable structural strength, and facilitates the mounting and fixation of the support assembly 32.

In some embodiments, as shown in FIG. 3 and FIG. 4, the support assembly 32 may include a support arm 321 and a support plate 322. The support arm 321 extends in a transverse direction, and both ends of the support arm are connected with the outer bellow 11. The support plate 322 is connected with the coupler 31. A part of the support plate 322 is supported on a bottom of the support arm 321. That is to say, the support plate 322 is not completely supported on the bottom of the support arm 321, and the support plate 322 and the support arm 321 are movable relative to each other in the transverse direction. The support plate 322 and the support arm 321 are frictionally engaged through a first wear-resistant structure 4. It should be noted that the “transverse direction” described herein is defined as a width direction of the rail vehicle 1000, the “longitudinal direction” is defined as a length direction of the rail vehicle 1000, and the “vertical direction” is defined as a height direction of the rail vehicle 1000.

In this way, the outer bellow 11 is connected with the support arm 321, so that the weight of the outer bellow 11 may be transferred to the support arm 321, and then a part of the support plate 322 is supported on the bottom of the support arm 321, so that the weight is transferred to the support plate 322 through the support arm 321. Finally, the support plate 322 is connected with the coupler 31, so that the weight of the outer bellow 11 is borne by the coupler 31. Therefore, the support assembly 32 can have a simple structure and is convenient to process and assemble.

In addition, when the rail vehicle 1000 passes through a turn, since the support arm 321 and the support plate 322 are movable relative to each other in the transverse direction, flexibility of the rail vehicle 1000 when passing through the turn can be improved. In addition, the support plate 322 and the support arm 321 are frictionally engaged through the first wear-resistant structure 4. Therefore, the wear between the support plate 322 and the support arm 321 can be reduced by the first wear-resistant structure 4, thereby increasing the service life of the support assembly 32. In addition, the abnormal sound generated by the friction between the support arm 321 and the support arm 321 may be reduced, so that loud noise can be prevented from being transferred into the rail vehicle 1000, thereby improving riding comfort of passengers.

It should be noted that the “connection” described in a preceding paragraph means a mechanical connection, which may be a fixed connection, a detachable connection, a direct connection, an indirect connection, or the like, which is not limited herein. In addition, it should further be noted that a material of the first wear-resistant structure 4 is not limited. For example, the material may be high molecular polyethylene, nylon, and the like, and the details will not be described herein.

In some embodiments, as shown in FIG. 4, the support plate 322 may include a base plate 3221 and two limit members 3222. The base plate 3221 is connected with the coupler 31, and a part of the base plate is supported on the bottom of the support arm 321. The limit members 3222 are arranged on the base plate 3221. The two limit members 3222 are arranged respectively on two longitudinal sides of the support arm 321 to limit relative positions of the support arm 321 and the base plate 3221. Therefore, a movement range of the support arm 321 may be limited by the limit members 3222. The support arm 321 is movable in the transverse direction and rotatable relative to the support plate 322, but unmovable in a longitudinal direction, so that the support arm 321 is movable only within a relatively small movement range (for example, a range of several millimeters).

For example, when the rail vehicle 1000 starts or brakes, the support arm 321 can only move relative to the support plate 322 in a movement direction of the rail vehicle 1000 within a reduced range of movement, so as to prevent the outer bellow 1 from moving substantially relative to the coupler 21 in the movement direction of the rail vehicle 1000. In this way, riding stability of the passengers in the gangway 100 is improved, and the problem such as leaning forward or backward of the passenger is alleviated. In addition, when the rail vehicle 1000 turns, since the support arm 321 is movable in the transverse direction or rotatable relative to the support plate 322, the flexibility and smoothness of the rail vehicle 1000 during turning can be improved.

In some embodiments, as shown in FIG. 4, the first wear-resistant structure 4 may include a first wear-resistant member 41 and a second wear-resistant member 42. The first wear-resistant member 41 is arranged on a bottom of the support arm 321 and two longitudinal sides of the support arm 321. The second wear-resistant member 42 is arranged on a top surface of the base plate 3221. Therefore, the support plate 322 and the support arm 321 are frictionally engaged through the first wear-resistant member 41 and the second wear-resistant member 42. That is to say, the bottom of the support arm 321 and the two longitudinal sides of the support arm 321 can be protected by the first wear-resistant member 41, and the top surface of the base plate 3221 can be protected by the second wear-resistant member 42. When the support arm 321 moves in the transverse direction relative to the base plate 3221, a top surface of the support arm 321 contacts and rubs against a bottom surface of the base plate 3221 through the first wear-resistant member 41 and the second wear-resistant member 42, and two longitudinal side surfaces of the support arm 321 contact and rub against the limit members 3222 through the first wear-resistant member 41.

In this way, the wear of the support arm 321 and the support plate 322 can be reduced, and the abnormal sound generated by the friction between the support arm 321 and the support arm 321 can also be reduced. Therefore, the service life of the support assembly 32 can be increased, and the loud noise can be prevented from being transferred into the rail vehicle 1000, thereby improving the riding comfort of the passenger. In addition, when a size of the second wear-resistant member 42 is relatively large, an avoidance hole 421 may be provided on the second wear-resistant member 42 for the limit member 3222 to pass through.

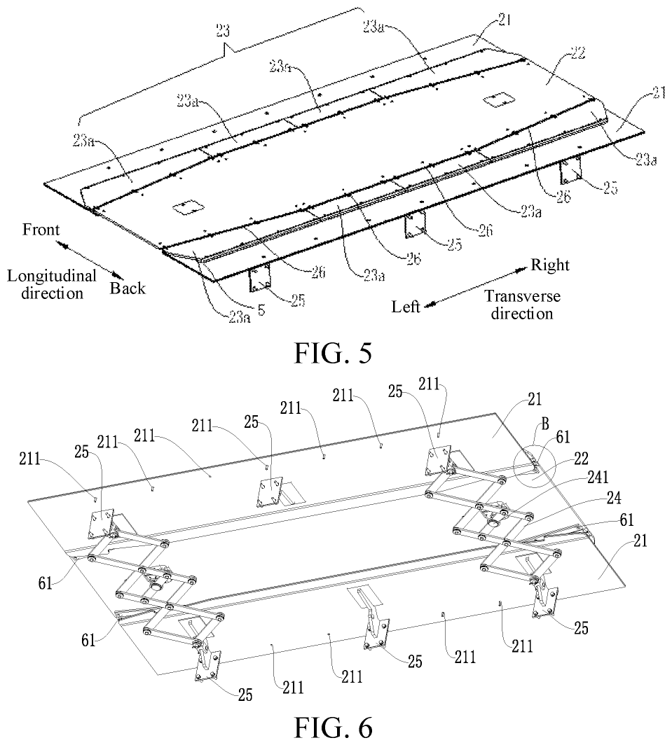

In some embodiments, as shown in FIG. 5, the step plate assembly 2 may include step plates 21, a bridge plate 22, and floating plates 23. Two step plates 21 are arranged. The two step plates 21 are spaced apart in the longitudinal direction of the rail vehicle 1000, and are respectively connected with two adjacent carriages 200. The bridge plate 22 is arranged above and between the two step plates 21. The bridge plate 22 is movably connected with the two adjacent carriages 200 through connecting members 24 below the step plates 21. The floating plates 23 are arranged respectively on two longitudinal sides of the bridge plate 22. Each floating plate 23 is movably connected with the bridge plate 22 and is lapped above the step plate 21 on a corresponding side. Therefore, when the rail vehicle 1000 passes through a turn with a small radius, a gap may be formed between the bridge plate 22 and the step plate 21. Since the floating plates 23 may hang down under the gravity, the floating plates 23 may cover the gap between the bridge plate 22 and the step plate 21, thereby improving use safety of the step plate assembly 2.

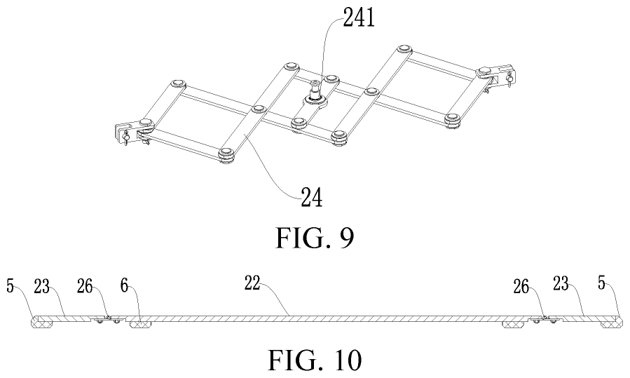

A specific mounting method of the step plate assembly 2 is not limited. For example, in a specific example shown in FIG. 6, multiple mounting holes 211 spaced apart and evenly arranged are provided on one side of a width direction of the step plates 21. The step plates 21 may be connected with the carriage 200 through threaded connecting members (such as screws, and the like). In addition, multiple step plate supports 25 may further be arranged on the bottom of the step plate 21 at intervals in a length direction of the step plate 21, and are configured to support the step plates 21. With reference to FIG. 8, each step plate support 25 may include a mounting portion 251, a support portion 253, and a connecting portion 252 connecting the mounting portion 251 with the support portion 253. The mounting portion 251 may be fixed to the carriage 200 through the threaded connecting members (such as screws, and the like), and the support portion 253 is supported on the bottom surface of the step plates 21. A through hole 2521 is further provided in the step plate support 25. With reference to FIG. 9, the connecting member 24 is formed into a scissor structure through multiple parallelogram structures. Two longitudinal ends of the connecting member 24 are respectively fixed in the through hole 2521 of the step plate support 25 on two longitudinal sides. A rotatable member 241 is further arranged in the middle of the connecting member 24. With reference to FIG. 6, the rotatable member 241 supports the bridge plate 22 and is rotatably connected with the bridge plate 22, so that the bridge plate 22 is movable with respect to the two rotatable members 241 as the center of rotation. Therefore, a distance change requirement of ends of two adjacent carriages 200 during operation may be satisfied, thereby improving the capability of passing through a turn with a relatively small radius by the rail vehicle 1000.

In some embodiments, as shown in FIG. 5, the floating plate 23 may include multiple sub-floating plates 23a arranged in sequence in an extending direction of a corresponding side edge of the bridge plate 22, so that the sub-floating plates 23a are arranged on an outer side of each longitudinal side edge of the bridge plate 22. One end of each sub-floating plate 23a is pivotally connected with the bridge plate 22 through a hinge 26, and another end of the sub-floating plate 23a is lapped above the step plate 21 on a corresponding side. Therefore, multiple sub-floating plates 23a are arranged to be pivotally connected with the step plates 21 through the hinge 26, so that the floating plates 23 can be mounted more conveniently and move more flexibly.

In some embodiments, as shown in FIG. 5 and FIG. 10, the floating plates 23 and the step plates 21 are frictionally engaged through a second wear-resistant structure 5. The second wear-resistant structure 5 is arranged on the other end of the sub-floating plate 23a (that is, one end of the sub-floating plate 23a lapped above the step plate 21 on the corresponding side). Therefore, when the sub-floating plates 23a hang down under the gravity and contact and rub against the step plates 21, the wear between the sub-floating plate 23a and the step plate 21 can be reduced. In this way, the service life of the sub-floating plates 23a and the step plates 21 is increased, and the noise generated when the sub-floating plates 23a rub against the step plates 21 is reduced, thereby improving the riding comfort of the passenger. It should be noted that a material of the second wear-resistant structure 5 is not limited. For example, the material may be high molecular polyethylene, nylon, and the like, and the details will not be described herein.

In some embodiments, as shown in FIG. 6, the bridge plate 22 and the step plates 21 are frictionally engaged through a third wear-resistant structure 6. The third wear-resistant structure 6 includes a wear-resistant strip 61 and a wear-resistant plate 62. The wear-resistant strip 61 is arranged on a bottom of the bridge plate 22 on each of two longitudinal sides of the bridge plate, and the wear-resistant plate 62 is arranged on a top surface of each of the step plates 21. When the rail vehicle 1000 turns, the bridge plate 22 and the step plates 21 may be frictionally engaged through the third wear-resistant structure 6, thereby reducing the noise generated during friction between the bridge plate 22 and the step plate 21, and improving the riding comfort of the passenger. It should be noted that a material of the third wear-resistant structure 6 is not limited. For example, the material may be high molecular polyethylene, nylon, and the like, and the details will not be described herein.

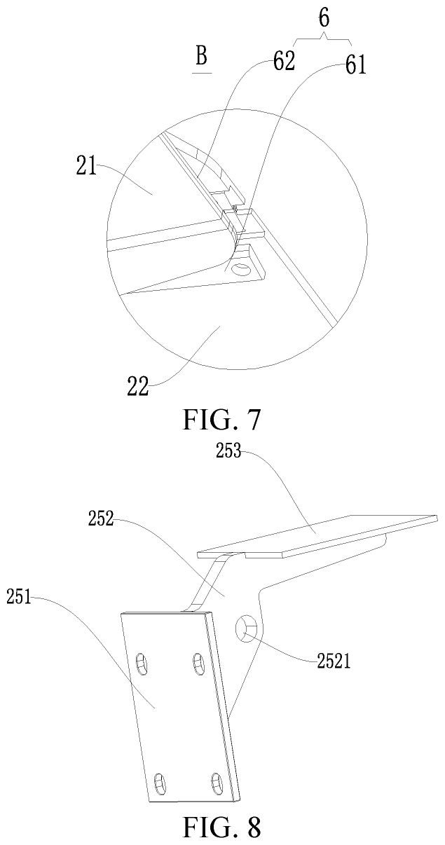

For example, in some specific embodiments, as shown in FIG. 6 and FIG. 7, the step plate 21 may be formed by upper and lower layers made of different materials. The upper layer of the step plate 21 (that is, a side close to the bridge plate 22) is the wear-resistant plate 62. The wear-resistant strip 61 is arranged on a bottom of the bridge plate 22 on each of the two longitudinal sides of the bridge plate. When the step plates 21 contact the bridge plate 22, the wear-resistant plate 62 and the wear-resistant strip 61 are frictionally engaged. The lower layer of the step plate 21 (that is, a side away from the bridge plate 22) is a metal plate configured to ensure the supporting strength. With reference to FIG. 8, the support portion 253 in the step plate support 25 supports a lower surface of the step plate 21. It should be noted that a connection form between the wear-resistant plate 62 on the upper layer of the step plate 21 and the metal plate on the lower layer is not limited. For example, the wear-resistant plate may be connected with the metal plate through the threaded connecting members (such as screws), and the like, and the details will not be described herein.

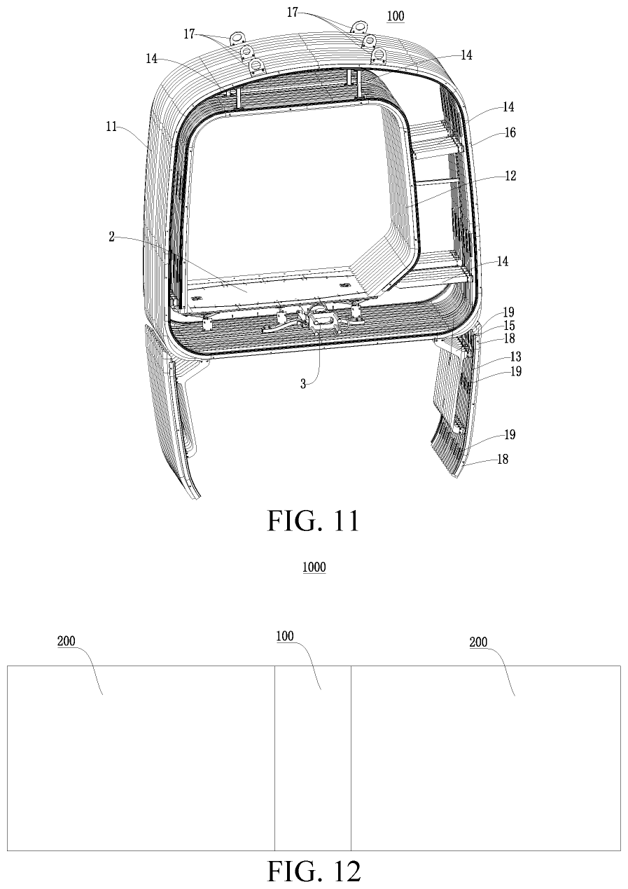

For example, in some specific embodiments, as shown in FIG. 11, the bellow assembly 1 is fixed (for example, by using the threaded connecting members) to an end wall of two adjacent carriages 200 through a vehicle body mounting frame 16 (with reference to FIG. 2). When the vehicle body mounting frame 16 and the carriage 200 are fixed, a rubber seal strip may further be arranged between the vehicle body mounting frame 16 and the carriage 200. In this way, the rubber seal strip closely contacts the carriage 200 to ensure the sealing requirement.

In some specific embodiments, as shown in FIG. 11, a detachable lug structure 17 is mounted to a top of the outer bellow 11, so as to facilitate the mounting of the outer bellow 11. For example, during mounting by using a hoisting device (such as a crane), the hoisting device may hook the lug structure 17, so that a contour of the outer bellow 11 is to be flush with an outer contour of the carriage 200 (not shown).

In some specific embodiments, as shown in FIG. 11, the inner bellow 12 is arranged inside the outer bellow 11, and the inner bellow 12 is non-symmetrically arranged with respect to the vertical centerline of the outer bellow 11. In addition, a contour of the inner bellow 12 is to be flush with a contour of an interior surface of the carriage 200 (not shown), and the inner bellow 12 and the outer bellow 11 are connected as a whole through a first connecting rod 14.

As shown in FIG. 11, in some specific embodiments, the gangway 100 may further include a skirt assembly 13. The skirt assembly 13 is fixed below the outer bellow 11. In this way, the skirt assembly 13 is arranged to shield a rail, a bogie, and the like. It should be noted that fixing forms in the expressions “the inner bellow 12 is fixed to the outer bellow 11” and “the skirt assembly 13 is fixed below the outer bellow 11” described herein are not limited. For example, the inner bellow 12 may be connected with the outer bellow 11 through the first connecting rod 14, the skirt assembly 13 may be connected with the outer bellow 11 through a second connecting rod 15, and the like, which is not limited thereto.

In some specific embodiments, as shown in FIG. 11, the outer bellow 11 and the inner bellow 12 in the bellow assembly 1 may be both composed of U-shaped bellow fabric. The U-shaped bellow fabric of the outer bellow 11 arches outward (that is, an arcuate surface faces an outer side of the carriage 200), and the U-shaped bellow fabric of the inner bellow 12 arches inward (that is, the arcuate surface faces an inner side of the carriage 200). The U-shaped bellow fabric may be made through sewing. For example, the U-shaped bellow fabric may further be treated through vulcanization, so that the U-shaped bellow fabric has desirable waterproofness and corrosion resistance. In addition, the U-shaped bellow fabric may be clamped and connected through a profiled framework (such as the aluminum profile, the aluminum alloy profile, and the like), so that the structural strength of the bellow assembly 1 can be improved, and the weight of the bellow assembly 1 can be reduced.

In some specific embodiments, as shown in FIG. 11, a bellow fabric structure of the skirt assembly 13 may be the same as that of the outer bellow 11, and the skirt assembly 13 is connected with the outer bellow 11 through a second connecting rod 15. Rubber strips 18 may further be arranged at intervals at upper and lower positions of the profiled framework of the skirt assembly 13, so as to buffer a collision between the profiled framework during operations and reduce noise. In addition, double-layer bellow fabric 19 is designed at the upper position, a middle position, and a lower position of the U-shaped bellow fabric, to enhance elasticity of the U-shaped bellow fabric of the skirt assembly 13. Therefore, the structural stability of the skirt assembly 13 is improved, thereby avoiding structural deformation of the skirt assembly 13 during the traveling of the rail vehicle.

With reference to the accompanying drawing, a rail vehicle 1000 according to an embodiment of a second aspect of the present disclosure is described below.

As shown in FIG. 12, a rail vehicle 1000 according to an embodiment of a second aspect of the present disclosure may include multiple carriages 200 and the gangway 100 for a rail vehicle 1000 according to the embodiment of the first aspect of the present disclosure. The gangway 100 is connected between two adjacent carriages 200.

According to the rail vehicle 1000 according to the embodiment of the second aspect of the present disclosure, the gangway 100 according to the embodiment of the first aspect of the present disclosure is arranged. For the gangway 100 in which the inner bellow 12 is non-symmetrically arranged with respect to the vertical centerline of the outer bellow 11, the load-bearing assembly 3 is arranged within the outer bellow 11, so that the upper avoidance recess configured to avoid the coupler 31 is not required to be formed on the outer bellow 11. In this way, a part of the step plate assembly 2 may extend to a position directly above the coupler 31, thereby providing a more spacious passageway 1a. In addition, it may be ensured that a center of gravity of the entirety of the gangway 100 is relatively low, thereby enhancing smoothness and safety of the rail vehicle 1000 during traveling.

In the description of this specification, the description of reference terms such as “one embodiment”, “some embodiments”, “example”, “specific example” or “some examples” means that specific features, structures, materials or characteristics described in combination with the embodiment or example are included in at least one embodiment or example of the present disclosure. In this specification, exemplary descriptions of the foregoing terms do not necessarily refer to a same embodiment or example. Moreover, the specific features, structures, materials, or characteristics described may be combined in any one or more embodiments or examples in a suitable manner. In addition, different embodiments or examples described in the present specification, as well as features of different embodiments or examples, may be integrated and combined by those skilled in the art without contradicting each other.

Although the embodiments of the present disclosure have been shown and described, a person of ordinary skill in the art should understand that various changes, modifications, replacements and variations may be made to the embodiments without departing from the principles and spirit of the present disclosure, and the scope of the present disclosure is as defined by the appended claims and their equivalents.

1.-11 (canceled)

12. A gangway for a rail vehicle, comprising:
a bellow assembly, comprising an outer bellow and an inner bellow fixed within the outer bellow, wherein a vertical centerline of the inner bellow is offset from a vertical centerline of the outer bellow;
a step plate assembly, arranged within the outer bellow and at a bottom of the inner bellow, and forming a passageway in combination with the inner bellow; and
a load-bearing assembly, arranged within the outer bellow and below the step plate assembly, and comprising a coupler and a support assembly, wherein the support assembly is connected with the outer bellow and the coupler, and the coupler is arranged below the step plate assembly.

13. The gangway according to claim 12, wherein a transverse dimension W2 of the step plate assembly is greater than half of a maximum transverse width W1 of the outer bellow.

14. The gangway according to claim 12, wherein the outer bellow comprises a middle connecting frame; a bottom frame of the middle connecting frame comprises a straight rim; and the support assembly is connected to the bottom frame.

15. The gangway according to claim 12, wherein the support assembly comprises:
a support arm, extending in a transverse direction, and both ends of the support arm connected with the outer bellow; and
a support plate, connected with the coupler and supporting a bottom of the support arm, wherein the support plate and the support arm are movable relative to each other in the transverse direction and are engaged through a first wear-resistant structure.

16. The gangway according to claim 15, wherein the support plate comprises:
a base plate, connected with the coupler and supported on the bottom of the support arm; and
two limit members, arranged on the base plate respectively on two longitudinal sides of the support arm, to limit relative positions of the support arm and the base plate.

17. The gangway according to claim 16, wherein the first wear-resistant structure comprises:
a first wear-resistant member, arranged on the bottom and the two longitudinal sides of the support arm; and
a second wear-resistant member, arranged on a top surface of the base plate.

18. The gangway according to claim 12, wherein the step plate assembly comprises:
two step plates, wherein the two step plates are longitudinally spaced and are respectively connected with two adjacent carriages;
a bridge plate, arranged above and between the two step plates, and movably connected with the two adjacent carriages through connecting members below the two step plates; and
two floating plates, respectively arranged on two longitudinal sides of the bridge plate, wherein each of the two floating plates is movably connected with the bridge plate and is lapped above a step plate on a corresponding side.

19. The gangway according to claim 18, wherein each of the two floating plates comprises a plurality of sub-floating plates arranged in sequence along a corresponding side edge of the bridge plate; a first end of each of the sub-floating plates is pivotally connected with the bridge plate through a hinge; and a second end of each of the sub-floating plate is lapped above the step plate on the corresponding side.

20. The gangway according to claim 19, wherein a first floating plate of the two floating plates and a corresponding step plate are engaged through a second wear-resistant structure; and the second wear-resistant structure is arranged on second ends of sub-floating plates of the first floating plate.

21. The gangway according to claim 18, wherein the bridge plate and the two step plates are engaged through a third wear-resistant structure; and the third wear-resistant structure comprises:
a wear-resistant strip, arranged on a bottom of the bridge plate on each of the two longitudinal sides of the bridge plate; and
a wear-resistant plate, arranged on a top surface of each of the two step plates.

22. A rail vehicle, comprising a plurality of carriages and a plurality of gangways, wherein each of the gangways is the gangway according to claim 12, and two adjacent carriages are connected by one of the gangways.
